(19) United States
(12) Patent Application Publication
(10) Pub. No.: US 2024/0426657 A1
(43) Pub. Date: Dec. 26, 2024

(54) Multi Spectral Digital Autocollimator

(71) Applicant: Oren Aharon, Haifa (IL)

(72) Inventor: Oren Aharon, Haifa (IL)

(21) Appl. No.: 18/213,290

(22) Filed: Jun. 23, 2023

(51) Int. Cl. G01J 3/02

(52) U.S. Cl. CPC G01J 3/0208; G01J 3/0237; G01J 2003/2826

(57) ABSTRACT

The present invention is a multi-spectral digital autocollimator system featuring a diverse range of capabilities. It comprises a multi-spectral light source spanning from deep UV to Far-IR (8-12 microns), a collimating mirror, a unique optical beam splitting lens, and an imaging device designed to detect the light deviation caused by the multi-spectral light source. The system projects the light through a specially designed cross target, generating visible light, and this cross target can be heated or cooled to create a high-quality black body cross. The resulting light is then reflected back from an examined reflective object and captured by the imaging device. An appropriate thermal camera is strategically positioned after the optical beam splitting lens to analyze the thermal properties of the black body cross. The primary objective of this invention is to offer a precise and multi-spectral digital autocollimator capable of facilitating optical alignment with different spectral devices.

### BACKGROUND OF THE INVENTION

### 1. Field of Invention

The present invention pertains to a precise and non-contact measuring device that possesses the capability to perform measurements over a wide multi-spectral bandwidth, enabling accurate alignment of components across a range of applications spanning from deep UV to Far-IR. Existing technology only addresses wavelengths within the visible and near IR range. The inspiration for this technology comes from an invention dating back 100 years, combined with the modern need for alignment across a broad spectrum, which was previously unattainable.

To achieve a wide spectral range autocollimator instrument, the disclosed art employs a unique optical design. This design incorporates a reflective telescope, a multi-spectral lens that functions as a beam splitter, and a groundbreaking light source capable of projecting a reference cross from deep UV to Far-IR. The multi-spectral reference image is positioned on the focal image plane of a preferred parabolical mirror, projecting the image to infinity. The reflected image from the mirror's light elements is collected by the parabolical mirror itself, which is equipped with a second focusing element designed to act as a beam splitter, focusing the incoming radiation onto a suitable imaging device to generate the required image. The data captured by the imaging device is then transferred to a microcontroller, which performs the necessary calculations using a dedicated algorithm to determine the angular deviation of the reflected beam. The objective of this invention is to provide a highly accurate measuring autocollimator capable of operating over a wide wavelength spectrum, thereby facilitating unprecedented measurements of multiple optical devices. One specific application for this technology is aligning the line of sight of devices that utilize multi-spectral windows, such as visible and FLIR, to coincide.

### 2. Description of the Related Art

The prior art technology pertains to an Autocollimator device that utilizes refractive lenses for performing measurements specifically within the visible and Near-IR wavelengths. The existing challenge lies in conducting measurements using other wavelengths, as there is a lack of light sources capable of producing multiple wavelengths, including thermal light, and a scarcity of optical components that can achieve high-quality imaging across the entire spectrum ranging from UV to Far-IR (8-12 microns). To address these challenges, the disclosed art presents a solution for constructing an Autocollimator with a broad spectral bandwidth. This solution involves utilizing a crossline multi-wavelength source combined with a thermal source, as well as incorporating a unique lens-based beam splitter. In certain cases where alignment measurements need to be performed across a wide spectral range, such as aligning and testing thermal imaging devices with regular cameras at various wavelengths, the disclosed art provides a means to overcome these obstacles. The primary objective of the disclosed art is to provide a solution for interdisciplinary applications that require the inter-alignment and testing of multiple wavelength devices. By introducing a multi-spectral digital autocollimator, it becomes possible to combine numerous spectral devices while conducting measurements that were previously unachievable.

### SUMMARY

The present invention provides a method and system to perform autocollimation measurements over multi-wavelengths range with a single device based on a unique optical design introducing multi-wavelengths (thermal and visible light) crossline targets combined with reflective and refractive optics where the refractive optical element provides a unique way for beam splitting over a wide spectral range.

To summarize, the disclosed multi-spectral digital autocollimator art comprises of a light source target that serves as a reference source for the autocollimator, emitting radiation across a wide spectrum ranging from 0.3 microns to 12 microns, a beam splitting lens featuring a surface that reflects the light emitted by the light source and focuses the back reflected light onto an imaging sensor, a reflective objective lens used for collimating the light emitted by the light source and capturing the back reflected light from an external mirror, an imaging device that receives and captures the back reflected image, and a microcontroller responsible for calculating the angular movement of the image generated by the imaging device. Completing the disclosed art, a linear stage that accommodates the imaging device and enables its back-and-forth movement in correspondence with the wavelength being tested, and a microcontroller device and algorithm responsible for providing driving instructions to the linear stage motor.

### BRIEF DESCRIPTION OF THE DRAWINGS

Further advantages of the invention will emerge from the following descriptions and drawings, which are provided as non-limiting example and in which:

FIG. 1 is a view describing the ray tracing of proposed embodiment of the present invention;

FIG. 2 is a cross-section of the optical system including its enclosure.

FIG. 3 describes the multi-wavelengths light source.

### DETAILED DESCRIPTION OF THE DRAWINGS

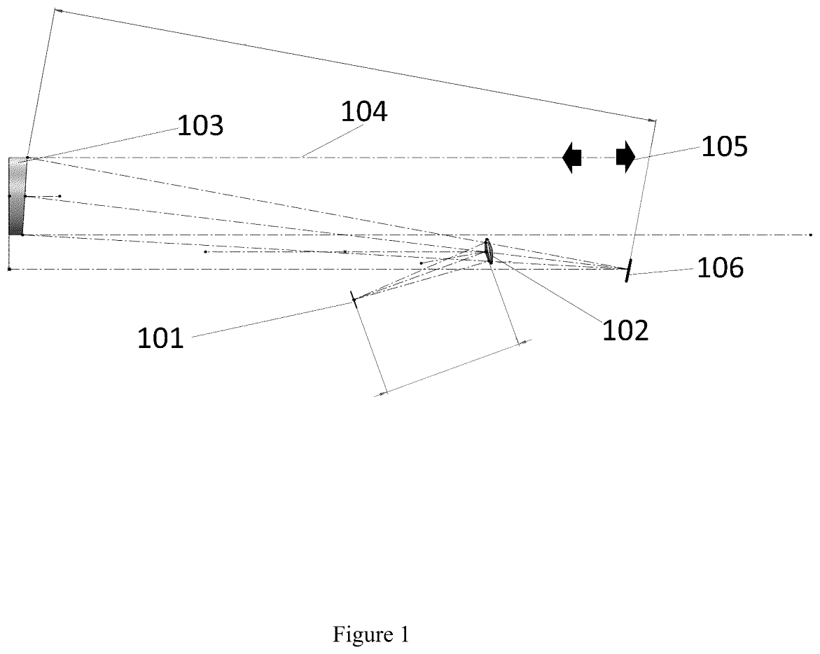

FIG. 1 provides a schematic representation of a system embodiment and a potential multi-wavelength light source. This light source generates a transparent cross-shaped target, which is back-illuminated by a lamp. The lamp is heated or cooled at its periphery to produce a thermal image, effectively covering the wavelength spectrum of the lamp and coinciding with the thermal image of the cross. The light source is labeled as 101. The light emitted by 101 is directed towards a lens, denoted as 102, which is constructed from a transparent material capable of transmitting all the necessary wavelengths, such as ZnSe. The front surface of the lens, referred to as 102, reflects the light towards a preferred reflective element, possibly a parabolic mirror, which collimates the projected light and directs it out of the system through the aperture. The projected light and the back reflected light are both collected and projected by element 103, with their directions indicated as 105. 104 represents the collimated light direction. The back reflected light then proceeds to the parabolic mirror, where it is partially focused. Subsequently, the light is further perfected and focused by the refractive element 102, and finally directed onto the detector device 106. The detector device 106 can be adjusted along the optical axis of the back projected light, either by a motorized stage or a regular stage, to accommodate varying distances for different wavelengths.

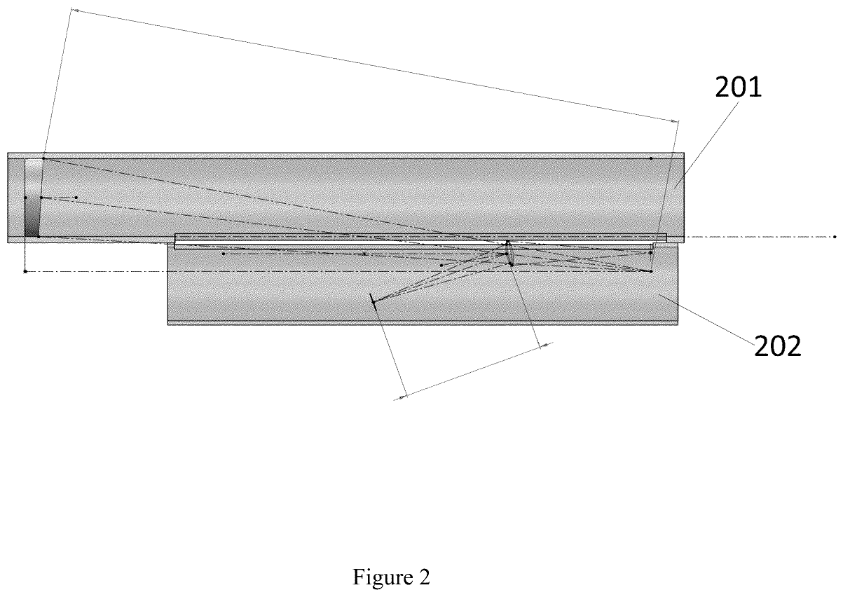

FIG. 2 illustrates a schematic representation of the envelope that encompasses the optical elements described in FIG. 1. The collimated telescope is enclosed within 201, while all the other elements, except for the parabolic mirror, are enclosed within 202.

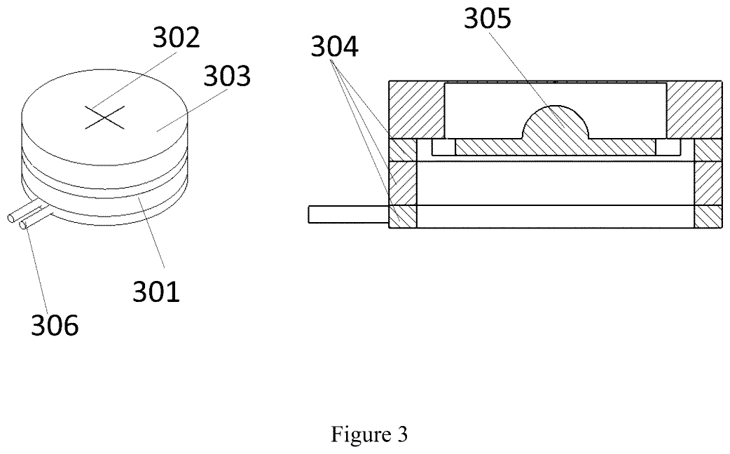

FIG. 3 presents a schematic representation of the light source 101 for enhanced clarity, utilizing a new schematic. This schematic consists of two views: a perspective view and a cross-section view. In the perspective view, 301 depicts a cooling/heating device, preferably a thermoelectric cooler. The see-through cross, denoted as 302, is machined on surface indicated by 303. Additionally, the cross-section view showcases the lamp, which back-illuminates the cross (302) and is labeled as 305. The thermoelectric cooler is represented by 304 in the cross-section view. Furthermore, the cross-section view reveals the direct connection between 303 and the thermoelectric cooler. For optimal performance, it is recommended that the material of element 303 has low thermal resistance, such as copper. The lamp and thermoelectric cooler receive electrical power through two wires designated as 306.

1. A multi-spectral digital autocollimator comprising:
a light source target that serves as a reference source for the autocollimator, emitting radiation across a wide spectrum ranging from 0.3 microns to 12 microns;
a beam splitting lens featuring a surface that reflects the light emitted by the light source and focuses the back reflected light onto an imaging sensor;
a reflective objective lens used for collimating the light emitted by the light source and capturing the back reflected light from an external mirror;
an imaging device that receives and captures the back reflected image; and
a microcontroller responsible for calculating the angular movement of the image generated by the imaging device.

2. A multi-spectral digital autocollimator according to claim 1, comprising of:
a linear stage that accommodates the imaging device and enables its back-and-forth movement in correspondence with the wavelength being tested; and
a microcontroller device and algorithm responsible for providing driving instructions to the linear stage motor.
